(19) United States
(12) Patent Application Publication
(10) Pub. No.: US 2023/0275368 A1
(43) Pub. Date: Aug. 31, 2023

(54) ELECTRIC ENERGY TRANSMISSION ALUMINUM PART, ALUMINUM CONNECTOR AND COPPER-ALUMINUM JOINT

(71) Applicant: JILIN ZHONG YING HIGH TECHNOLOGY CO., LTD., Jilin (CN)

(72) Inventors: Chao WANG, Jilin (CN); Xiaolin XUE, Jilin (CN)

(21) Appl. No.: 17/915,961

(22) PCT Filed: Apr. 1, 2021
(86) PCT No.: PCT/CN2021/084916

§ 371 Date: Sep. 29, 2022

(30) Foreign Application Priority Data
Apr. 1, 2020 (CN) 202020456090.6

(51) Int. Cl. H01R 4/62; H01R 4/18; H01R 4/72; H01R 4/02

(52) U.S. Cl. CPC H01R 4/625; H01R 4/18; H01R 4/72; H01R 4/029

(57) ABSTRACT

An electric energy transmission aluminum part, an aluminum connector and a copper-aluminum joint. The electric energy transmission aluminum part includes an aluminum body (1) internally provided with a conical insertion hole (11) which penetrates through front and rear ends thereof. The conical insertion hole is provided with a maximum diameter end and a minimum diameter end. Both the aluminum connector and the copper-aluminum joint include the electric energy transmission aluminum part. The electric energy transmission aluminum part, the aluminum connector and the copper-aluminum joint not only avoid an insulation layer (3) from being crimped into a lead portion and increasing a resistance of the lead portion, but also prevent an indentation from being formed on the surface of the insulation layer (3) and causing breakdown, and further reduce an interference with a mating end environment, thus achieving a wide application range. In addition, the copper-aluminum joint can also save the processing working hours and resources.

### CROSS-REFERENCE TO RELATED APPLICATION

The present disclosure claims the priority of Chinese utility model patent No. 202020456090.6, and entitled “electric energy transmission aluminum part, aluminum connector and copper-aluminum joint”.

### TECHNICAL FIELD

The present disclosure relates to a technical field of automobiles, and particularly to an electric energy transmission aluminum part for automobiles, an aluminum connector with the electric energy transmission aluminum part, and a copper-aluminum joint with the aluminum connector.

### BACKGROUND

Copper or copper alloy is widely used in the field of electrical connections due to its good electrical conductivity, thermal conductivity, and plasticity. However, there is a shortage of copper resources, and the content of copper in the earth's crust is only about 0.01%. With the increase of the usage time, the cost of copper will rise year by year. Therefore, people begin to look for alternatives for metal copper to reduce the cost.

The content of metal aluminum in the earth's crust is about 7.73%. With the refining technology of aluminum being optimized, the price of aluminum is relatively low. Aluminum also has excellent electrical conductivity, thermal conductivity, and plastic workability. Therefore, it is a main development trend at present to replace copper with aluminum in the field of automobile electrical connections.

Compared with copper, aluminum has slightly lower hardness, plasticity and corrosion resistance, but its weight is lighter, and its conductivity ranks only second to that of copper. Thus, aluminum can partially replace copper in the field of electrical connections. However, due to a large electrode potential difference between copper and aluminum, an electrochemical corrosion will occur between the directly connected copper and aluminum, such that aluminum is susceptible to the corrosion and a resistance in the connection area may increase, which will easily lead to serious consequences such as functional failures and fires in the electrical connections.

In order to solve the problem of electrochemical corrosion caused by the direct contact between copper and aluminum, Chinese invention patent CN103354308B discloses a copper-aluminum joint, including an aluminum wire, an aluminum tube, a copper wiring terminal, and a welding layer. The aluminum wire includes a wire harness and an insulation layer wrapping the wire harness. The aluminum wire is sleeved by the aluminum tube which has one end located on a wire harness (i.e. a lead) removed of the insulation layer at an end portion of the aluminum wire, and the other end located on an adjacent insulation layer. The inner wall of the aluminum tube is stepped, with an inner stepped surface matched with an end surface of the insulation layer. The welding layer is located between the aluminum wire and the copper terminal. The processing method thereof is to use the aluminum tube with an inner stepped surface to crimp the lead and the insulation layer of the aluminum wire, respectively, then connect the aluminum tube and the copper terminal by friction welding, and finally seal with a heat-shrinkable tube.

Crimping both the lead and the insulation layer of the aluminum wire in the aluminum tube has the following disadvantages.

1. The front end of the insulation layer may be pressed into the lead, resulting in an increased resistance of the lead and local heating thereof, which will eventually cause accidents such as vehicle burning.

2. After the welding is completed, the terminal and the aluminum wire are all sealed with the heat-shrinkable tube, which wastes working hours and resources.

3. The length of the aluminum tube needs to be increased to be crimped with the insulation layer, which will cause the aluminum tube to interfere with the mating end environment in practical applications, resulting in a narrow application range.

4. An indentation will be formed on the insulation surface of the insulation layer after being crimped, which will easily cause breakdowns in use.

### SUMMARY

In order to overcome the disadvantages of the prior art, the present disclosure provides an electric energy transmission aluminum part, which not only avoids an insulation layer from being crimped into a lead portion and increasing a resistance of the lead portion, but also prevents an indentation from being formed on a surface of the insulation layer and causing breakdown, and further reduces an interference with a mating end environment, thus achieving a wider application range. The present disclosure further provides an aluminum connector with the electric energy transmission aluminum part, and a copper-aluminum joint with the aluminum connector. In addition, the copper-aluminum joint can also reduce processing working hours, reduce material waste and save resources.

In order to solve the above technical problem, the present disclosure adopts the following technical solutions.

The present disclosure provides an electric energy transmission aluminum part, including an aluminum body internally provided with a conical insertion hole which penetrate through front and rear ends thereof, with the conical insertion hole being provided with a maximum diameter end and a minimum diameter end.

The present disclosure further provides an aluminum connector, including an aluminum cable and the aforementioned electric energy transmission aluminum part, wherein the aluminum cable comprises an aluminum conductor and an insulation layer cladding a periphery of the aluminum conductor; a section of the aluminum conductor stripped of the insulation layer is accommodated in the conical insertion hole with the maximum diameter end adjacent to the insulation layer, and the conical insertion hole and the aluminum cable are crimped to form the aluminum connector.

The present disclosure further provides a copper-aluminum joint, including a copper terminal and the aforementioned aluminum connector, wherein the copper terminal is connected to the aluminum connector, between which a transition layer with metal atoms penetrating into or combined with each other is formed.

Compared with the prior art, the present disclosure has the following advantageous effects.

1. In the electric energy transmission aluminum part according to the present disclosure, the aluminum body is internally provided with a conical insertion hole. During use, a section of the aluminum conductor stripped of the insulation layer in the aluminum cable is inserted in the conical insertion hole with the maximum diameter end adjacent to the insulation layer. When the conical insertion hole is crimped with the aluminum cable, the maximum diameter end of the conical insertion hole is subjected to stress and expanded outwards at a certain angle to be far away from the aluminum conductor and the insulation layer, which on the one hand reduces the possibility of sharp cutting of the aluminum conductor by the electric energy transmission aluminum part, and on the other hand prevents a resistance of a lead portion from being increased as the insulation layer is crimped into the lead portion, and further avoids breakdown caused by an indentation formed on the surface of the insulation layer. Meanwhile, it is unnecessary to increase the length of the electric energy transmission aluminum part, thereby reducing the interference with the mating end environment and extending the application range. Moreover, the conical structure insertion hole is beneficial to reducing the resistance to the insertion of the aluminum conductor.

2. The aluminum body with a conical structure is beneficial to reducing the resistance to the insertion of the aluminum conductor. In addition, the conical structure facilitates a tighter crimping of the front end of the aluminum connector. The length of the electric energy transmission aluminum part allows the stress of the aluminum conductor to be effectively released during the crimping process, so as to effectively avoid the longitudinal cutting of the aluminum cable at the crimped end.

3. The maximum diameter end of the conical insertion hole may be provided with a chamfered structure, i.e., a chamfer is provided at an inner side and/or an outer side of the maximum diameter end. The chamfer provided at the inner side of the maximum diameter end can effectively reduce the impact on the aluminum cable, and the chamfer provided at the outer side of the maximum diameter end can effectively avoid the influence of the sharp corners of the conical insertion hole on the external environment.

4. The aluminum body with a columnar structure is convenient to be clamped by a fixture to apply stress without damaging the aluminum conductor. Compared with the monofilament-stranded structure of the aluminum conductor, the aluminum body, as a solid columnar structure, is not easy to be damaged and has greater welding strength, larger welding surface, and better welding performance.

5. The aluminum body with a cylindrical structure is beneficial to uniformly receiving the external stress during welding and clamping.

6. A limiting platform may be provided at the maximum diameter end of the conical insertion hole to prevent the insulation layer of the aluminum cable from entering the conical insertion hole, which can effectively limit an insertion amount of the aluminum conductor, realize a standardized operation, and further effectively prevent the insulation layer of the aluminum cable from participating in the crimping, thus avoiding the risk of breakdown.

7. The aluminum body of the electric energy transmission aluminum part partially acts as a conductor when being crimped with the aluminum cable to form the aluminum connector, thus increasing the conductivity of the aluminum connector.

8. The copper-aluminum joint may further include a heat-shrinkable tube which dads a connecting position of the copper terminal and the aluminum connector. After the welding is completed, the non-sealed or non-vacuum use area is sealed with the heat-shrinkable tube, which on the one hand avoids the copper terminal and the aluminum cable from being corroded by external media, and on the other hand prevents the aluminum cable from being bent or even broken due to local stress.

### BRIEF DESCRIPTION OF THE DRAWINGS

FIG. 1 illustrates a schematic structural diagram of a first exemplary embodiment of an aluminum connector according to the present disclosure;

FIG. 2 illustrates a first schematic structural diagram of a second exemplary embodiment of an aluminum connector according to the present disclosure;

FIG. 3 illustrates a second schematic structural diagram of the second exemplary embodiment of an aluminum connector according to the present disclosure;

FIG. 4 illustrates a schematic structural diagram of a third exemplary embodiment of an aluminum connector according to the present disclosure;

FIG. 5 illustrates a schematic structural diagram of a fourth exemplary embodiment of an aluminum connector according to the present disclosure.

### REFERENCE NUMERALS

1. aluminum body; 11. conical insertion hole; 2. aluminum conductor; 3. insulation layer; 4. chamfered structure; 5. limiting platform.

### DETAILED DESCRIPTION

In order to further explain the technical means adopted by the present disclosure to achieve the intended invention objective and effects thereof, the specific implementations, structures, characteristics and effects of the present disclosure will be described in detail below with reference to the drawings and the exemplary embodiments.

### The First Embodiment

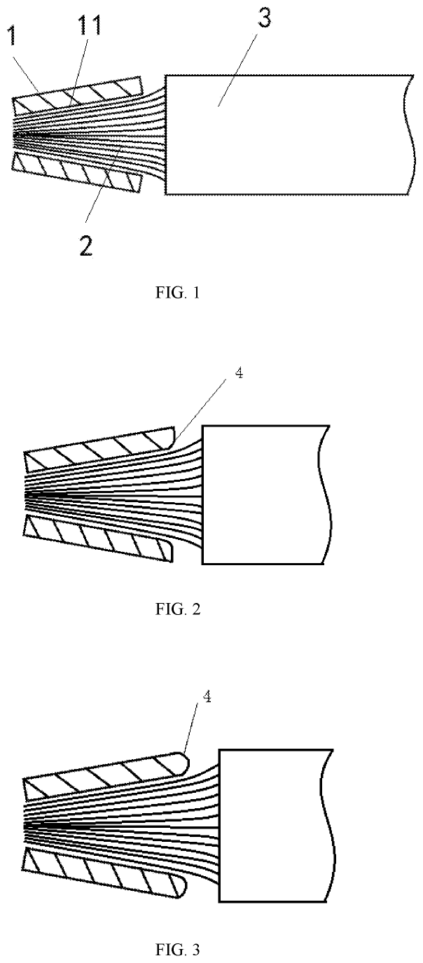

As illustrated in FIG. 1, an aluminum connector with an electric energy transmission aluminum part of a first embodiment according to the present disclosure includes an aluminum body 1 and an aluminum cable. The aluminum cable includes an aluminum conductor 2 and an insulation layer 3 cladding a periphery of the aluminum conductor 2. The aluminum body is internally provided with a conical insertion hole 11 penetrating through front and rear ends thereof. The conical insertion hole is provided with a maximum diameter end and a minimum diameter end. During use, a section of the aluminum conductor stripped of the insulation layer in the aluminum cable is inserted in the conical insertion hole with the maximum diameter end adjacent to the insulation layer. When the conical insertion hole is crimped with the aluminum cable to form the aluminum connector, the maximum diameter end of the conical insertion hole is subjected to stress and expanded outwards at a certain angle to be far away from the aluminum conductor and the insulation layer, which on the one hand reduces the possibility of sharp cutting of the aluminum conductor by the electric energy transmission aluminum part, and on the other hand prevents a resistance of the aluminum conductor from being increased as the insulation layer is crimped into the lead portion, and further avoids breakdown caused by an indentation formed on the surface of the insulation layer. Meanwhile, it is unnecessary to increase the length of the electric energy transmission aluminum part, thereby reducing the interference with the mating end environment and extending the application range.

The aluminum body is of a conical structure, which is beneficial to reducing the resistance to the insertion of the aluminum conductor. In addition, the conical structure facilitates a tighter crimping of the front end of the aluminum connector. The length of the electric energy transmission aluminum part allows the stress of the aluminum conductor to be effectively released during the crimping process, so as to effectively avoid the longitudinal cutting of the aluminum cable at the crimped end.

The aluminum body has a uniform wall thickness.

The aluminum connector may be adopted to manufacture a copper-aluminum joint, which is structurally composed of a copper terminal and the aluminum connector. The copper terminal is connected to the aluminum connector, between which a transition layer with metal atoms penetrating into or combined with each other is formed.

The transition layer with metal atoms penetrating into or combined with each other is formed between the copper terminal and the aluminum connector by friction welding, laser welding, resistance welding, pressure welding, ultrasonic welding, or arc welding.

The copper-aluminum joint further includes a heat-shrinkable tube which dads a connecting position of the copper terminal and the aluminum connector. The heat-shrinkable tube is used to directly seal the electric energy transmission aluminum part and the insulation layer, and it is unnecessary to crimp the insulation layer with the aluminum tube and then seal them with the heat-shrinkable tube as in the prior art, thus saving working hours and resources. Moreover, after the welding is completed, the non-sealed or non-vacuum use area is sealed with the heat-shrinkable tube, which on the one hand avoids the copper terminal and the aluminum cable from being corroded by external media, and on the other hand prevents the aluminum cable from being bent or even broken due to local stress.

### The Second Embodiment

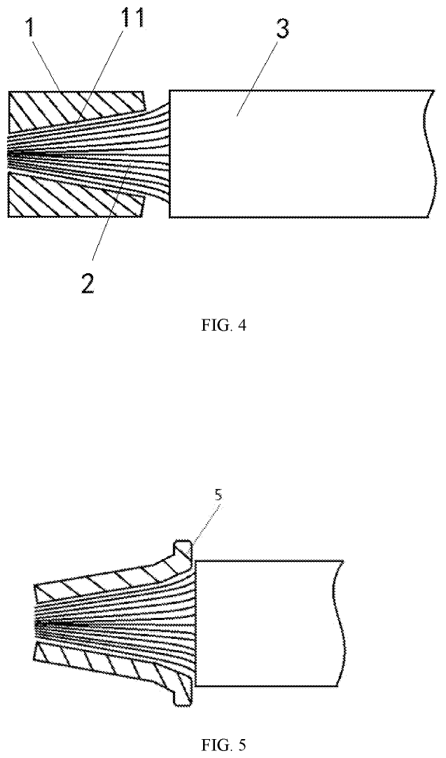

An aluminum connector with an electric energy transmission aluminum part of a second embodiment according to the present disclosure differs from the first embodiment illustrated in FIG. 1 in that the maximum diameter end of the conical insertion hole is provided with a chamfered structure 4. Specifically, as illustrated in FIG. 2, the chamfered structure 4 is provided at an inner side of the maximum diameter end, which can effectively reduce the impact on the aluminum cable. Alternatively, the chamfered structure is provided at an outer side of the maximum diameter end, which can effectively avoid the influence of the sharp corner of the conical insertion hole on the external environment. Alternatively, as illustrated in FIG. 3, the inner side and the outer side of the maximum diameter end are provided with the chamfered structure 4 respectively.

The aluminum connector may be adopted to manufacture a copper-aluminum joint, which is structurally composed of a copper terminal and the aluminum connector. The copper terminal is connected to the aluminum connector, between which a transition layer with metal atoms penetrating into or combined with each other is formed.

The transition layer with metal atoms penetrating into or combined with each other is formed between the copper terminal and the aluminum connector by friction welding, laser welding, resistance welding, pressure welding, ultrasonic welding, or arc welding.

The copper-aluminum joint further includes a heat-shrinkable tube which dads a connecting position of the copper terminal and the aluminum connector. The heat-shrinkable tube is used to directly seal the electric energy transmission aluminum part and the insulation layer, and it is unnecessary to crimp the insulation layer with the aluminum tube and then seal them with the heat-shrinkable tube as in the prior art, thus saving working hours and resources. Moreover, after the welding is completed, the non-sealed or non-vacuum use area is sealed with the heat-shrinkable tube, which on the one hand avoids the copper terminal and the aluminum cable from being corroded by external media, and on the other hand prevents the aluminum cable from being bent or even broken due to local stress.

### The Third Embodiment

As illustrated in FIG. 4, an aluminum connector with an electric energy transmission aluminum part of a third embodiment according to the present disclosure only differs from the aluminum connector illustrated in FIG. 1 in that the aluminum body 1 has a different shape. In this embodiment, the aluminum body 1 is of a columnar structure, which is convenient to be clamped by a fixture to apply a stress without damaging the aluminum conductor. Compared with the monofilament-stranded structure of the aluminum conductor, the aluminum body, as a solid columnar structure, is not easy to be damaged and has greater welding strength, larger welding surface, and better welding performance. As a further exemplary solution of this embodiment, the aluminum body 1 is of a cylindrical structure, which is beneficial to uniformly receiving the external stress during welding and clamping.

The aluminum body has a non-uniform wall thickness.

The aluminum connector may be adopted to manufacture a copper-aluminum joint, which is structurally composed of a copper terminal and the aluminum connector. The copper terminal is connected to the aluminum connector, between which a transition layer with metal atoms penetrating into or combined with each other is formed.

The transition layer with metal atoms penetrating into or combined with each other is formed between the copper terminal and the aluminum connector by friction welding, laser welding, resistance welding, pressure welding, ultrasonic welding or arc welding.

The copper-aluminum joint further includes a heat-shrinkable tube which dads a connecting position of the copper terminal and the aluminum connector. The heat-shrinkable tube is used to directly seal the electric energy transmission aluminum part and the insulation layer, and it is unnecessary to crimp the insulation layer with the aluminum tube and then seal them with the heat-shrinkable tube as in the prior art, thus saving working hours and resources. Moreover, after the welding is completed, the non-sealed or non-vacuum use area is sealed with the heat-shrinkable tube, which on the one hand avoids the copper terminal and the aluminum cable from being corroded by external media, and on the other hand prevents the aluminum cable from being bent or even broken due to local stress.

### The Fourth Embodiment

As illustrated in FIG. 5, an aluminum connector with an electric energy transmission aluminum part of a fourth embodiment according to the present disclosure only differs from the aluminum connector illustrated in FIG. 1 in that the aluminum body 1 has a different shape. In this embodiment, the aluminum body 1 is provided with a limiting platform 5 at the maximum diameter end of the conical insertion hole, which can effectively limit an insertion amount of the aluminum conductor, realize a standardized operation, and effectively prevent the insulation layer of the aluminum cable from participating in the crimping, thus avoiding the risk of breakdown.

Meanwhile, if there is a plastic connector that needs to be plugged in, this limiting platform may be taken as a positioning point for effective mounting.

The aluminum connector may be adopted to manufacture a copper-aluminum joint, which is structurally composed of a copper terminal and the aluminum connector. The copper terminal is connected to the aluminum connector, between which a transition layer with metal atoms penetrating into or combined with each other is formed.

The transition layer with metal atoms penetrating into or combined with each other is formed between the copper terminal and the aluminum connector by friction welding, laser welding, resistance welding, pressure welding, ultrasonic welding or arc welding.

The copper-aluminum joint further includes a heat-shrinkable tube which dads a connecting position of the copper terminal and the aluminum connector. The heat-shrinkable tube is used to directly seal the electric energy transmission aluminum part and the insulation layer, and it is unnecessary to crimp the insulation layer with the aluminum tube and then seal them with the heat-shrinkable tube as in the prior art, thus saving working hours and resources. Moreover, after the welding is completed, the non-sealed or non-vacuum use area is sealed with the heat-shrinkable tube, which on the one hand avoids the copper terminal and the aluminum cable from being corroded by external media, and on the other hand prevents the aluminum cable from being bent or even broken due to local stress.

Those described are only exemplary embodiments of the present disclosure, and cannot limit the protection scope of the present disclosure. Any insubstantial change or substitution made by those skilled in the art on the basis of the present disclosure should fall within the protection scope of the present disclosure.

1. An electric energy transmission aluminum part, comprising an aluminum body internally provided with a conical insertion hole which penetrate through front and rear ends thereof, with the conical insertion hole being provided with a maximum diameter end and a minimum diameter end.

2. The electric energy transmission aluminum part according to claim 1, wherein the aluminum body is of a conical structure, with a uniform or non-uniform wall thickness.

3. The electric energy transmission aluminum part according to claim 1, wherein the aluminum body is of a columnar structure.

4. The electric energy transmission aluminum part according to claim 3, wherein the aluminum body is of a cylindrical structure.

5. The electric energy transmission aluminum part according to claim 1, wherein the maximum diameter end of the conical insertion hole is provided with a chamfered structure.

6. The electric energy transmission aluminum part according to claim 11, wherein the maximum diameter end of the conical insertion hole is provided with a limiting platform.

7. An aluminum connector, comprising an aluminum cable and the electric energy transmission aluminum part according to claim 1, wherein the aluminum cable comprises an aluminum conductor and an insulation layer cladding a periphery of the aluminum conductor; a section of the aluminum conductor stripped of the insulation layer is accommodated in the conical insertion hole with the maximum diameter end adjacent to the insulation layer, and the conical insertion hole and the aluminum cable are crimped to form the aluminum connector.

8. A copper-aluminum joint, comprising a copper terminal and the aluminum connector according to claim 7, wherein the copper terminal is connected to the aluminum connector, between which a transition layer with metal atoms penetrating into or combined with each other is formed.

9. The copper-aluminum joint according to claim 8, wherein the transition layer with metal atoms penetrating into or combined with each other is formed between the copper terminal and the aluminum connector by friction welding, laser welding, resistance welding, pressure welding, ultrasonic welding, or arc welding.

10. The copper-aluminum joint according to claim 9, further comprising a heat-shrinkable tube which dads a connecting position of the copper terminal and the aluminum connector.
